(19) United States
(12) Patent Application Publication
(10) Pub. No.: US 2009/0066267 A1
(43) Pub. Date: Mar. 12, 2009

(54) Arrangement and method for driving light-emitting components

(75) Inventors: Robert Kraus, Regensburg (DE); Bakuri Lanchava, Regensburg (DE); Wjatscheslaw Kutschenko, Mainz (DE)

Correspondence Address: OSRAM SYLVANIA INC, 100 ENDICOTT STREET, DANVERS, MA, 01923, US

(73) Assignee: OSRAM GESELLSCHAFT MIT BESHRANKTER HAFTUNG, MUNCHEN (DE)

(21) Appl. No.: 12/230,471

(22) Filed: Aug. 29, 2008

(30) Foreign Application Priority Data
Aug. 30, 2007 (DE) 10 2007 041 131.8

(51) Int. Cl. H05B 37/00

(52) U.S. Cl. 315/313

(57) ABSTRACT

The invention relates to an arrangement for driving at least two light-emitting components connected in a series circuit, wherein the series circuit is coupled to a supply voltage, in each case a switching unit with respective switching terminals is coupled in parallel connection to each of the at least two components and each switching unit has two states.

The invention relates to an arrangement and also a method for driving at least two light-emitting components connected in a series circuit.

In principle, light sources are differentiated as natural and artificial light sources; this application is concerned only with artificial light sources.

Various methods are known nowadays for generating light. Traditional generation of light is achieved by means of so-called thermal emitters. They supply a continuous radiation as the temperature increases. The best-known light source appertaining to this method is the incandescent lamp. Here an electrical conductor is heated by means of electric current. Since said electrical conductor has a positive temperature coefficient, that is to say can be referred to as a PTC thermistor, a fixed operating point is set after the energy supply has been switched on. The heating of the electrical conductor, which is tungsten, for example, results in the spontaneous emission of light particles predominantly in the visible and infrared wavelength range.

A more efficient variant for generating light is achieved by means of non-thermal emitters. For this purpose, molecules or atoms are put into an excited state by feeding in energy. Upon recombination, the electrons emit the energy as radiation with a characteristic wavelength. Chemical excitation, for example in luminous rods, electrical excitation, for example used in semiconductor components, lasers and fluorescent tubes, but also X-ray radiation and radioactivity may be applicable as feeding in energy. Especially in the case of semiconductor components, a distinction is made between spontaneous and stimulated emission of light.

The difference between spontaneous and stimulated emissions is based on the property of the light obtained. In the case of stimulated emission, the wavelength is quasi-monochromatic and the light propagates with a specific polarization. As a result, the light has specific coherence properties. By contrast, neither wavelength nor propagation of the light is fixed in the case of spontaneous emission.

In principle, it can be stated that non-thermal emitters have a significantly higher efficiency than thermal emitters when generating light. A major cause of this is the high proportion of infrared radiation; more energy is converted into heat than into light.

Typical applications in which non-thermal emitters are used are widely varied. As a rough outline, such light sources are used as lighting equipment, for example as ceiling lighting, as torch and the like. However, such light sources can also be found in projection devices, as backlighting, as automotive headlights, as status display and much more. They are increasingly superceding the thermal emitters owing to the lower power loss and correspondingly higher efficiency. In this case, the efficiency is defined in terms of the efficiency of the light source. The latter is in turn defined by energy used in relation to light energy emitted. An LED used as a light-emitting semiconductor component can nowadays attain an efficiency of up to 60%, whereas an incandescent lamp has only 10%.

In a typical application, a plurality of light-emitting components are connected up in series.

Current drivers are used nowadays for driving light-emitting components connected up in series. They provide the drive voltage, for example, and possibly additionally limit the current. Current limiting in this case is necessary, for example, in order to protect a semiconductor component against destruction or overloading. These so-called voltage/current driver components occasionally regulate the current flowing through the series circuit and limit it when a specific limit value is exceeded.

What is disadvantageous about this type of driving is a long dark phase of the light-emitting components if they are operated for example with a changing voltage, for example an AC voltage. Hereinafter an AC voltage is regarded as an electrical voltage that changes its polarity at least once per period.

Artificial light sources have the property of already taking up a certain amount of energy before the light is emitted. Especially in the case of semiconductor components, no current flow and accordingly no light emission are possible before a so-called threshold voltage is exceeded. This phase is referred to as the enhancement phase. Only when the threshold voltage is exceeded does the sudden rise occur in the current-voltage characteristic curve, which consequently leads to light emission.

When light-emitting components are connected in a series circuit, said threshold voltage accumulates since a specific voltage is necessary per component in order to be able to activate said component. This accumulated threshold voltage has to be exceeded by a drive circuit in order to lead to the desired light emission. Since, precisely in the case of driving by means of AC voltage, this increased threshold voltage has to be exceeded for each period, a very much smaller time window is available for converting energy into light. The applied signal power is accordingly significantly higher than the light power obtained, whereby the efficiency deteriorates.

By using rectifying circuits that convert the negative polarity of a drive AC voltage into a positive polarity, for example a two-bridge rectifier, the efficiency is improved, in principle, since the negative polarity is likewise used for generating light. However, the increased threshold voltage is in principle maintained in this case.

It is therefore an object of the invention to provide an arrangement and a method for driving light-emitting components. It is desireable to obtain a high efficiency.

The object is achieved by the measures in the coordinate patent claims.

According to one embodyment, an arrangement for driving at least two light-emitting components connected in a series circuit is provided, wherein the at least two components have a first and a second terminal, the series circuit is coupled to a supply voltage, in each case a switching unit with respective switching terminals is coupled in parallel connection to each of the at least two components, and each switching unit has two states. The switching unit can bridge the respective component in a first state and cannot bridge the respective component in a second state. The respective state of the switching unit is changed by means of a switching signal that is fed.

What is achieved by this arrangement is that the components connected up in series can be bridged, in principle.

If e.g. an AC voltage is applied to this series circuit, then firstly only one component is not bridged; all the other components are bridged. As a result, the smallest possible threshold voltage is set for the overall series circuit. The applied AC voltage, which increases continuously in a positive rise, for example, will cause the component to emit light as soon as the value of the AC voltage is higher than the value of the threshold voltage. As a result, an AC voltage source can be utilized optimally and an efficient conversion of the electrical energy into light radiation is achieved. This active load setting additionally has the effect of minimizing the power loss.

Further advantageous configurations are described in the subordinate patent claims.

In one advantageous configuration, the arrangement has a control unit, which generates switching signals for the switching units and is additionally coupled to the supply voltage.

What can be achieved is that the arrangement generates switching signals by means of a control unit, wherein the supply voltage is also available in the control unit. As a result of this, the control of the switching signals is centrally coordinated and the change in the states of the switching units is carried out at a more precise point in time.

In a further advantageous configuration, the switching unit changes from the first state to the second state as soon as the magnitude of the supply voltage exceeds a defined value, and changes from the second state to the first state as soon as the magnitude of the supply voltage falls below a defined value.

In this advantageous configuration, the state is changed when a defined value is exceeded or undershot. Said value is dependent on the number of series-connected components and the number of bridged components. By means of these values, the actual threshold voltage is determined and a decision is taken as to when a further component is bridged or not bridged. This results in an increase in efficiency since the control unit defines a precise voltage point for example for each situation. What can be achieved is that the circuit emits light in principle starting from an earliest possible point in time and the total dark phase of the circuit is minimal.

In one advantageous configuration, further components are provided in said series circuit, which components can in turn be coupled in parallel with additional switching elements.

What The series circuit to be driven is not limited to two semiconductor components, rather a chain of components is available in order to achieve a specific luminous intensity or a specific illumination of an illumination area.

In a further advantageous configuration, a current limiting unit is inserted between series circuit and supply voltage. Said unit ensures that the current within the series circuit does not exceed a possibly critical limit value, and thus prevents the circuit from being destroyed. In addition, the current limiting unit serves to stabilize the operating point, such that a possible exceeding of a maximum efficiency point within the characteristic curve of the components is not exceeded.

In one advantageous configuration, the current of the series circuit is fed back to the control unit as a controlled variable. A real-time measurement of the current is possible by virtue of this measure, whereby the control unit carries out a real-time comparison with the defined ranges for changing the switching states and can react to given irregularities. Such irregularities could be the failure of a component or a momentary overvoltage in the supply voltage.

In a further advantageous configuration, an AC voltage is converted into a pulsating DC voltage in a rectifying element (rectifying unit). As a result of this, it is possible to use the negative polarity of the AC voltage likewise for generating light and to increase the efficiency of the circuit further.

In a further advantageous configuration, the control unit has a random generator. This random generator switches the switching signals in a random order to the corresponding switching units, whereby the selected components are bridged or not bridged. What can be achieved is that all the components are bridged or not bridged as far as possible equally often and thereby experience as far as possible identical ageing.

In a further advantageous configuration, the switching signals are applied in such a way that the component that is the first to change its state is also the first again to change its state back.

What can be achieved is that a component that is switched on first is also switched off again first, whereby all the components are selected as far as possible equally often.

The concept of the invention can include a use of two arrangements which are operated correspondingly oppositely.

What can be achieved is that an AC voltage does not have to be converted into a pulsating DC voltage as supply voltage, rather one arrangement is assigned per polarity of the AC voltage. The arrangement can be configurated for driving the at least two components and at least two further light emitting components coupled to the supply voltage, wherein the conducting direction of the at least two further components is opposite to the conducting direction of the at least two components. The supply voltage (Ub, Gnd) has two different polarities for the opposite conducting directions of the components, i.e. the at least two components can be fed by a voltage of a first polarity and the at least two further components can be fed by a voltage of a second polarity. Application of the correct voltage to the respective components can be regulated by the switching units. This means that the components and the further components having the opposite conducting direction can be comprised together in the series circuit.

The invention is explained below on the basis of exemplary embodiments with reference to the drawings, wherein the figures of identical or identically acting constituent parts are in each case identified by the same reference symbols. The elements illustrated should not be regarded as true to scale, rather individual elements may be illustrated without an exaggerated size, or with exaggerated simplification, in order to afford a better understanding.

In the figures:

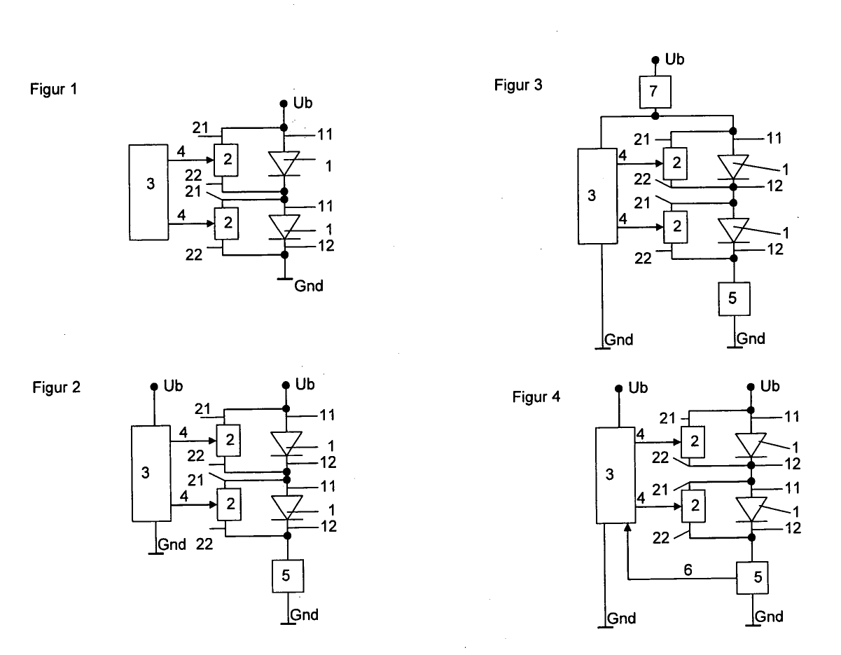

FIG. 1 shows a first exemplary embodiment for driving light-emitting components,

FIG. 2 shows a development of the exemplary embodiment illustrated in FIG. 1 for driving light-emitting components,

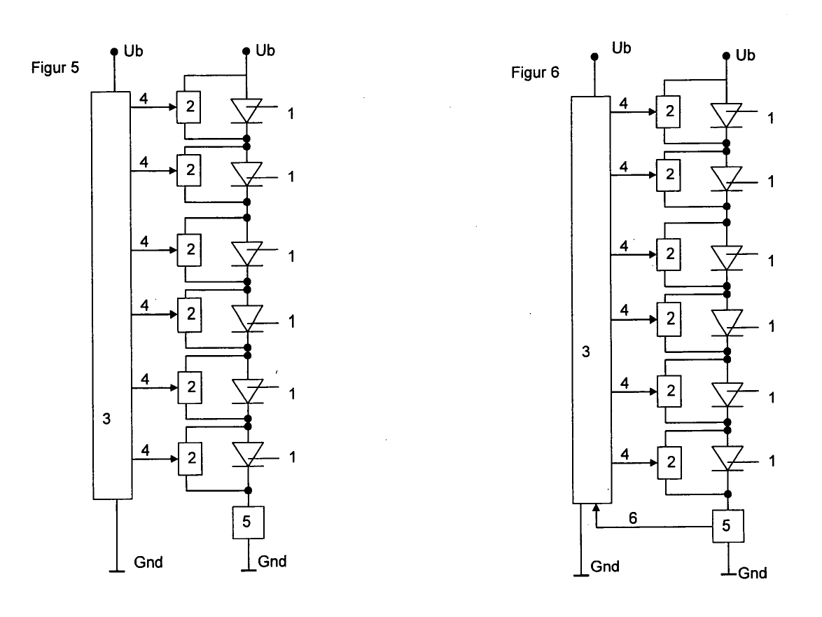

FIG. 3 shows a development of the exemplary embodiment illustrated in FIG. 2 for driving light-emitting components,

FIG. 4 shows a development of the exemplary embodiment illustrated in FIG. 2 for driving light-emitting components,

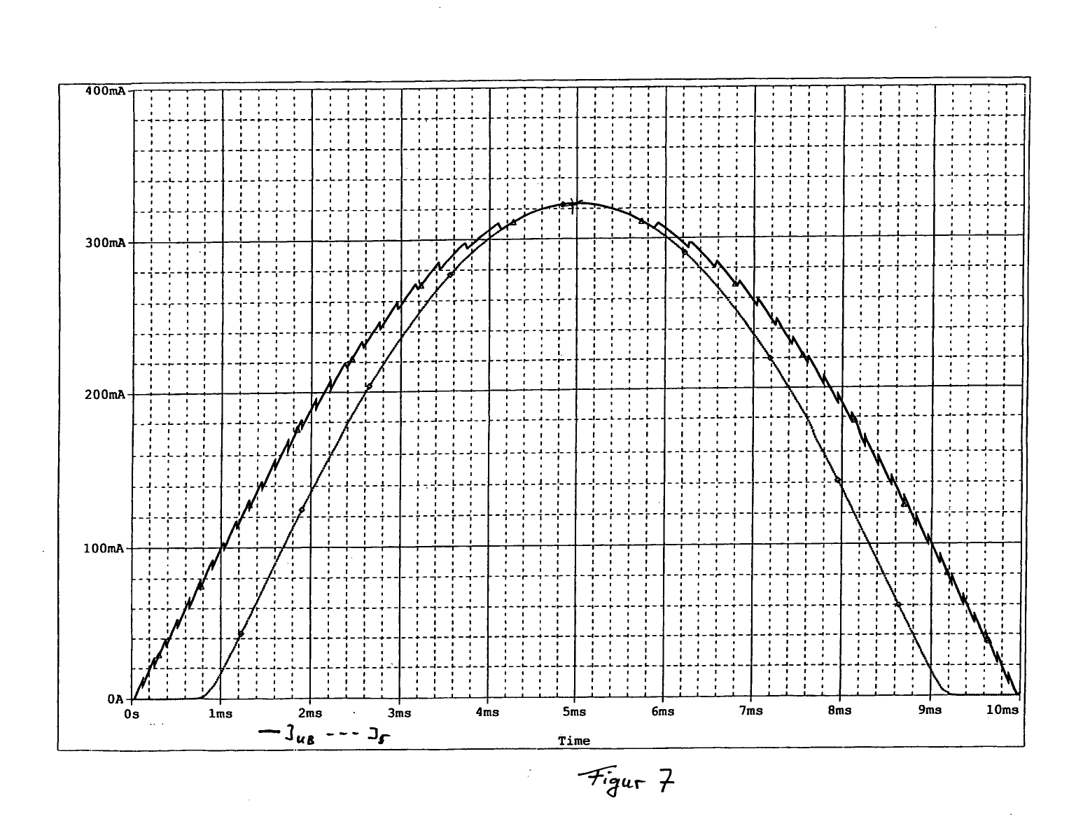

FIG. 5 shows a development of the exemplary embodiment illustrated in FIG. 1 for driving light-emitting components,

FIG. 6 shows a development of the exemplary embodiment illustrated in FIG. 4 for driving light-emitting components, and

FIG. 7 shows a current-time diagram with a current profile of the supply voltage and the current in the series circuit.

FIG. 1 shows an arrangement provided for driving light-emitting components 1. In the following figures, the light-emitting component is a light-emitting diode. Two light-emitting diodes 1 are illustrated here. Each light-emitting diode has a first terminal 11 and a second terminal 12. The terminal 11 corresponds to an anode terminal and terminal 12 corresponds to a cathode terminal of a light-emitting diode. The anode terminal 11 of the second light-emitting diode 1 is connected to the cathode terminal 12 of the first light-emitting diode 1. This results in a series circuit of two light-emitting diodes 1. A supply voltage UB, GND is applied to this series circuit. In the simple case this supply voltage UB, GND is an AC voltage having different polarities.

A switching unit 2 is connected in parallel with each LED. In this case, each switching unit 2 has two switching terminals 21, 22, wherein terminal 21 is coupled to the first terminal 11 and terminal 22 is coupled to the second terminal 12. In addition, FIG. 1 shows a control unit 3, which generates switching signals 4. These switching signals 4 are fed to the respective switching unit 2.

The function of the circuit arrangement will now be described below. Assuming that the supply voltage UB, GND is an AC voltage, for example a sinusoidal voltage having a peak voltage of 5 volts, which has a voltage magnitude of 0 at the instant t=0. This voltage point is established as the starting point for the description.

A light-emitting diode 1 typically has a threshold voltage of approximately 0.6 to 0.7 V. If the series circuit is not bridged by the switching units 2, then the threshold voltage in total is a maximum of 1.4 V. Without the switching units, therefore, an AC voltage only above 1.4 V would lead to the emission of light from the light-emitting diode. At a peak voltage of 5 volts, the light-emitting diodes 1 have a comparatively long dark phase.

If the control unit 3 is now configured such that a switching signal 4 is applied to one of the two switching units 2 at the instant t=0, whereby the switching unit 2 is in a first state, specifically in the bridging state, and the associated light-emitting diode 1 is thus bridged, then only one light-emitting diode in the series circuit is active for the supply voltage. The threshold voltage correspondingly decreases to 0.6 to 0.7 volts. The supply voltage increases at the instant t>0, whereby the first diode starts to emit light at Ub>0.7 V.

Upon a further increase in the AC voltage to a value Ub>1.4 V, it is possible to add the second light-emitting diode 1 to the series circuit, whereby both light-emitting diodes emit light. If the supply voltage reaches a value Ub>1.4 V, the control unit 3 applies a switching signal 4 to the switching unit 2 that is in the state one, that is to say bridging. As a result of the applied switching signal 4, the associated switching unit 2 changes from the state one to the state two and no longer bridges the corresponding light-emitting diode 1. Consequently, both LEDs are connected up in series. Since UB>1.4 V and thus greater than twice the threshold voltage, both light-emitting diodes 1 now emit light.

What can be achieved is that the dark phases of the overall series circuit are reduced and, by targeted switching-in of the components in the series circuit starting from a specific voltage value, the series circuit emits light with increased efficiency as possible.

FIG. 2 shows a development of the exemplary embodiment illustrated in FIG. 1. Since FIG. 1 and FIG. 2 are very similar, only the differences in FIG. 2 are indicated in the description below. The control unit 3 additionally has terminals for the driving of the supply voltage UB, GND. Furthermore, a current limiting unit 5 is arranged between the series circuit and the reference potential Gnd of the supply voltage Ub.

The circuit functions substantially as described in FIG. 1. The current limiting unit 5 monitors the current in the overall series circuit and limits it as soon as it exceeds a critical maximum value. In the simplest case, the current limiting unit is a resistor, and a regulated current source is provided in a more complex arrangement. This prevents possible destruction or overloading of the light-emitting diodes 1. In addition, a maximum value which sets an operating point beyond which the light-emitting diodes cannot be operated efficiently can be defined in the current limiting element 5.

FIG. 3 shows a development of the exemplary embodiment illustrated in FIG. 2. Here, too, there is a high degree of similarity with respect to FIG. 2, whereby here in turn only the differences from FIG. 2 are indicated. In addition to the embodiment already described, a rectifying unit 7 is provided between the supply voltage potential Ub and the control unit 3 and the light-emitting diode series circuit. An applied supply voltage, which is a pure AC voltage, for example, is thereby converted into a pulsating DC voltage. Consequently, the negative polarity of the supply voltage Ub, Gnd is likewise used for generating light, which signifies an increase in the efficiency of the overall drive circuit. By way of example, a two-bridge rectifying system is provided as the rectifying unit.

FIG. 4 shows an alternative development of the exemplary embodiment illustrated in FIG. 2. In contrast to FIG. 2, the control unit 3 has an input to which the current value 6 of the series circuit is fed back. Said current value is generated or determined from the current limiting unit 5.

This feedback of a controlled variable to the control unit 3 provides a real-time measurement of the current, whereby the control unit 3 can react to rapidly changing measures, for example excessive current increases or failure of a component. This exemplary embodiment has a very high efficiency and a minimized dark phase of the series circuit.

FIG. 5 shows an alternative development of the exemplary embodiment illustrated in FIG. 2. In contrast to FIG. 2, the series circuit comprises six light-emitting diodes connected up in series. Each of the light-emitting diodes 1 is coupled in parallel with a switching unit 2 and can be bridged or not bridged by said unit. The number of light-emitting diodes is in no way restricted here, but rather can vary depending on the respective use of the arrangement.

In a version of the exemplary embodiment that is not illustrated, it is likewise conceivable for not every light-emitting diode 1 to be coupled in parallel with the switching unit 2, but rather for possibly specific strings of the series-connected light-emitting diodes 1 to be connected to a respective switching unit 2 or only every third diode to be connected to a switching unit.

FIG. 6 specifies a development of the exemplary embodiment illustrated in FIG. 4. In a manner similar to that in FIG. 5, here six light-emitting diodes are illustrated and always connected up in a real-time monitoring by virtue of the feedback of the current value 6.

FIG. 7 shows a current-time diagram with a current profile of the supply current IB and a current profile of the current through a series circuit having 25 light-emitting diodes 1 in the time period from 0 to 10 ms. The light-emitting diodes are of the Golden Dragon LA W57B type. A resistor having a value of 300 ohms was used as a current limiting unit. Furthermore, 25 switching units were switched by means of a control unit, wherein each switching unit has a resistance of 50 megohms in the switched-off state. The supply voltage applied was 110 Vrms at 50 Hz. The switching units gradate the supply voltage in 6V steps. The dashed line in this case shows the current I5 through the series circuit.

A current flow in the series circuit starts from an input current IB=80 mA. This shows that already only a small input current (proportional to the threshold voltage) has to flow in order that the series circuit turns on. The higher the input current IB becomes, the more the current I5 through the series circuit approximates to the input current IB. At the maximum value of the input current IB at approximately 320 mA, I5=IB. FIG. 7 shows that a very precise approximation of the input current IB to the series circuit current I5 is provided and a maximum efficiency with regard to input power in relation to output power is generated as a result.

The illustration does not show a random generator that can be situated within the control unit. In this case, the random generator randomly selects the switching signals 4. What can be achieved is that all the LEDs have an as far as possible identical number of operating periods. The illustration likewise does not show a drive circuit within the control unit that makes it possible for the first LED always to be switched on first and also switched off again first in the falling branch of the input current.

For smoothing voltage and current spikes, an inductance can also be connected upstream of the series circuit, said inductance making it possible to smooth the input currents and input voltage. In principle, with the measures specified the power loss can be reduced or minimized by active setting of the load.

In particular, the control unit 3 has at least one comparator that compares the present current value or voltage value with a nominal current value or nominal voltage value. If the present current value or voltage value is greater than the preset nominal current value or nominal voltage value, then the control unit 3 controls at least one of the switching units 2 in such a way that this switching unit 2 is switched from the bridging state to the bridged state.

For decoupling the outputs and inputs of the switching units, the switching units have in particular a relay or optocoupler.

The operating voltage potential is ideally (220-240) V, whereby the arrangement can be operated from the mains voltage.

1. Arrangement for driving at least two light-emitting components (1) connected in a series circuit that is coupled to a supply voltage (Ub, Gnd), the arrangement comprising a switching unit (2) for each of the at least two components, each switching unit having a first and a second state, being fed with a switching signal (4) and being suitable for
being coupled in parallel connection to the respective component,
bridging the respective component (1) in the first state,
not bridging the respective component (1) in the second state, and
changing the state depending on the switching signal (4).

2. Arrangement according to claim 1, further comprising a control unit (3) that generates the switching signals (4) for the switching units (2) and is coupled to the supply voltage (Ub, Gnd).

3. Arrangement according to claim 2, wherein at least one of the switching units (2) is switched from the first state to the second state by means of the switching signal (4) as soon as the magnitude of the supply voltage (Ub, Gnd) or the current (6) through the series circuit exceeds a defined value, and at least one of the switching units (2) is switched from the second state to the first state by means of the switching signal (4) as soon as the magnitude of the supply voltage (Ub, Gnd) or the current (6) through the series circuit falls below a defined value.

4. Arrangement according to claim 1, that is suitable for driving one or more further light-emitting components (1) that are comprised in the series circuit.

5. Arrangement according to claim 4, wherein further switching units (2) for each of the further components are comprised.

6. Arrangement according to claim 1, wherein a current limiting unit (5) is arranged between the supply voltage (Ub, Gnd) and the series circuit.

7. Arrangement according to claim 2, wherein the supply voltage (Ub, Gnd) or the current (6) through the series circuit is available to the control unit as a controlled variable.

8. Arrangement according to claim 1, wherein the supply voltage (Ub, Gnd) is an AC voltage and is converted into a pulsating DC voltage by means of a rectifying unit (7).

9. Arrangement according to claim 2, wherein the control unit (3) comprises a random generator that randomly selects the order of the switching units to be switched by the switching signals (4).

10. Arrangement according to claim 1, wherein that switching unit (2) which is the first to be switched from the first state to the second state is also the first to be switched from the second state to the first state.

11. Arrangement according to claim 1, wherein the component (1) is an LED.

12. Arrangement according to claim 1 for driving the at least two components and at least two further light emitting components that are coupled to the supply voltage, wherein the conducting direction of the at least two further components is opposite to the conducting direction of the at least two components, and the supply voltage (Ub, Gnd) has two different polarities for feeding the opposite conducting directions of the components.

13. Method for driving light-emitting components, wherein
the components are connected in a series circuit,
a supply voltage is fed to the series circuit,
a switching unit is arranged in parallel with each component,
each of the switching units can be switched from a state bridging the component to a state not bridging the component,
a switching signal is fed to the switching units in order to switch the state of the respective switching unit, wherein
the switching signal is fed in a manner dependent on a magnitude of the supply voltage or the current (6) through the series circuit.

14. Method according to claim 13, wherein a control unit is used for generating the switching signals, and the magnitude of the supply voltage or the current through the series circuit is made available as a controlled variable in the control unit.

15. Method according to claim 13, wherein an AC voltage is available as supply voltage and is converted into a pulsating DC voltage by means of a rectifying unit.

16. Method according to claim 13, wherein the switching signals are generated in such a way that all the switching units change their states equally often.

17. Method according to claim 14, wherein an AC voltage is available as supply voltage and is converted into a pulsating DC voltage by means of a rectifying unit.

18. Method according to claim 14, wherein the switching signals are generated in such a way that all the switching units change their states equally often.

19. Method according to claim 15, wherein the switching signals are generated in such a way that all the switching units change their states equally often.

20. Arrangement according to claim 2, that is suitable for driving one or more further light-emitting components (1) that are comprised in the series circuit.
